(19) United States
(12) Patent Application Publication
(10) Pub. No.: US 2021/0333787 A1
(43) Pub. Date: Oct. 28, 2021

(54) DEVICE MANAGEMENT SYSTEM, MODEL LEARNING METHOD, AND MODEL LEARNING PROGRAM

(71) Applicant: NEC CORPORATION, Tokyo (JP)

(72) Inventors: Satoru YAMANO, Minato-ku, Tokyo (JP); Norihito FUJITA, Minato-ku, Tokyo (JP); Tomohiko YAGYU, Minato-ku, Tokyo (JP)

(73) Assignee: NEC CORPORATION, Tokyo (JP)

(21) Appl. No.: 16/606,537

(22) PCT Filed: Apr. 20, 2017
(86) PCT No.: PCT/JP2017/015831

§ 371 Date: Oct. 18, 2019

(51) Int. Cl. G05B 23/02

(52) U.S. Cl. CPC G05B 23/0254

(57) ABSTRACT

A device management system includes a learning unit 81 for learning a state model representing a normal state of a system including a control target device, based on a control sequence representing one or more time-series commands and data indicating a state of the control target device when the control sequence is issued.

### TECHNICAL FIELD

The present invention relates to a device management system for managing a control device, and a model learning method and a model learning program for learning a model used to manage the control device.

### BACKGROUND ART

Recently, the numbers of incidents reported in industrial control systems are increasing each year, and more advanced security measures are needed.

For example, Patent Literature (PTL) 1 describes a security monitoring system for detecting unauthorized access, malicious programs, and the like. The system described in PTL 1 monitors communication packets in a control system, and generates a rule from communication packets whose feature values are different from normal. The system described in PTL 1 detects an abnormal communication packet based on this rule, and predicts its influence on the control system.

PTL 2 describes an apparatus for learning a machine control method. The apparatus described in PTL 2 outputs, based on preregistered control instructions and detected signals of state changes of an operation mechanism part, a control signal for causing the operation mechanism part to operate in a desired operating state in order of operating states.

### CITATION LIST

### Patent Literatures

PTL 1: Japanese Patent Application Laid-Open No. 2013-168763
PTL 2: Japanese Utility Model Application Laid-Open No. H04-130976

### SUMMARY OF INVENTION

### Technical Problem

Since there are various methods of attacking systems, a number of security measures are taken. It is, however, difficult to apply a typical security measure to a system composed of an embedded device (hereafter also referred to as “physical line system”). It is therefore difficult to protect a whole industrial control system including a physical line system using only the typical security measure.

For example, suppose an attack of unauthorizedly rewriting a control program for controlling the physical line system is made. Even when the typical security measure is applied to the industrial control system, in the case where a command or packet used for a control instruction is not abnormal, a process by the control program that causes execution of inappropriate control is hard to be detected promptly.

An example of an attack that causes execution of inappropriate control is an attack of performing inappropriate control for the state of the system to cause abnormal operation of the device (hereafter also referred to as “operating state incompatibility”). For example, an instruction to increase temperature is transmitted to an air conditioner despite room temperature being high, to crash a server.

The system described in PTL 1 assumes destination address, data length, and protocol type as feature values, and assumes a combination of address, data length, and protocol type as a rule. The system described in PTL 1 also assumes whole system stop, segment/control apparatus stop, and warning as processes corresponding to influence.

The system described in PTL 1 determines, on a packet basis, whether the packet is abnormal. There is accordingly a problem in that, for example in the case where a command or a packet itself is not abnormal, the foregoing high-level attack cannot be detected by merely monitoring the communication state. To guard the control device against such an attack, it is preferable that inappropriate control can be detected to appropriately manage the target device even in the case where a command or a packet itself is not abnormal.

The apparatus described in PTL 2 learns the next control instruction based on the current state. There is accordingly a problem in that the foregoing high-level attack cannot be detected in the case where an attack of unauthorizedly rewriting a control instruction learned by the apparatus described in PTL 2 is made.

The present invention therefore has an object of providing a device management system capable of detecting inappropriate control and appropriately managing a target device, and a model learning method and a model learning program for learning a model used to manage the target device.

### Solution to Problem

A device management system according to the present invention includes a learning unit which learns a state model representing a normal state of a system including a control target device, based on a control sequence representing one or more time-series commands and data indicating a state of the control target device when the control sequence is issued.

A model learning method according to the present invention includes learning a state model representing a normal state of a system including a control target device, based on a control sequence representing one or more time-series commands and data indicating a state of the control target device when the control sequence is issued.

A model learning program according to the present invention causes a computer to execute a learning process of learning a state model representing a normal state of a system including a control target device, based on a control sequence representing one or more time-series commands and data indicating a state of the control target device when the control sequence is issued.

### Advantageous Effects of Invention

According to the present invention, inappropriate control can be detected to appropriately manage a target device.

### BRIEF DESCRIPTION OF DRAWINGS

FIG. 1 is a block diagram depicting an exemplary embodiment of a device management system according to the present invention.

FIG. 2 is an explanatory diagram depicting an example of a process of generating a state model and detecting an abnormality of a system.

FIG. 3 is an explanatory diagram depicting an example of a process of detecting operating state incompatibility.

FIG. 4 is an explanatory diagram depicting another example of a process of detecting operating state incompatibility.

FIG. 5 is a flowchart depicting an example of operation of the device management system.

FIG. 6 is a flowchart depicting another example of operation of the device management system.

FIG. 7 is a block diagram schematically depicting a device management system according to the present invention.

### DESCRIPTION OF EMBODIMENT

An exemplary embodiment of the present invention will be described below, with reference to the drawings.

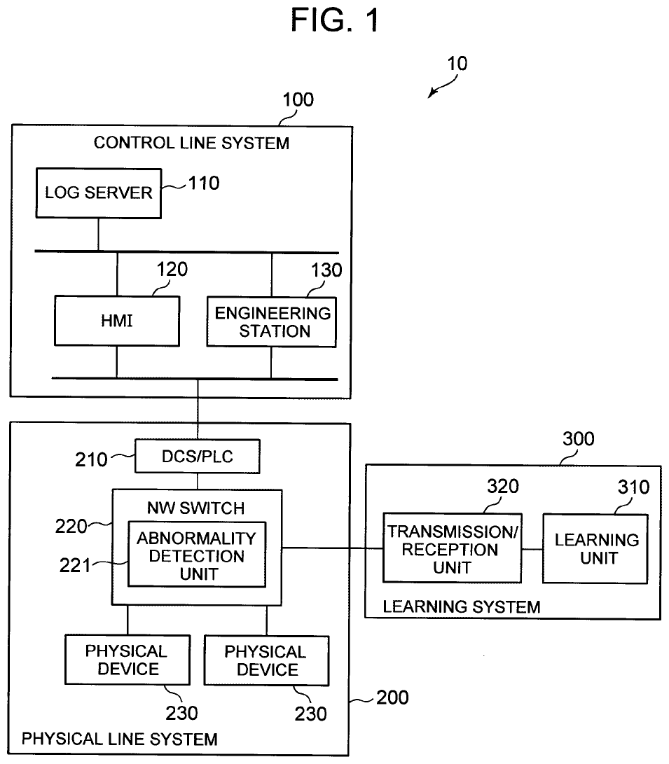

FIG. 1 is a block diagram depicting an exemplary embodiment of a device management system according to the present invention. An industrial control system 10 including the device management system in this exemplary embodiment includes a control line system 100, a physical line system 200, and a learning system 300. The learning system 300 depicted in FIG. 1 corresponds to the whole or part of the device management system according to the present invention.

The control line system 100 includes a log server 110 for collecting logs, a human machine interface (HMI) 120 used for communication with an operator in order to monitor or control the system, and an engineering station 130 for writing a control program to the below-described distributed control system/programmable logic controller (DCS/PLC) 210.

The physical line system 200 includes the DCS/PLC 210, a network (NW) switch 220, and physical devices 230.

The DCS/PLC 210 controls each physical device 230 based on the control program. The DCS/PLC 210 is implemented by a widely known DCS or PLC.

The NW switch 220 monitors a command transmitted from the DCS/PLC 210 to each physical device 230 and a packet in response to the command. The NW switch 220 includes an abnormality detection unit 221. The abnormality detection unit 221 detects commands issued to a control target physical device 230, in chronological order (i.e. in time series). One or more time-series commands are hereafter referred to as a control sequence.

Although this exemplary embodiment describes the case where the abnormality detection unit 221 is included in the NW switch 220, the abnormality detection unit 221 may be implemented by hardware independent of the NW switch 220. For example, all packets received by the NW switch 220 may be copied and transferred to a device including the abnormality detection unit 221 so as to perform detection in the device. The abnormality detection unit 221 corresponds to part of the device management system according to the present invention.

The abnormality detection unit 221 detects the state of the control target physical device 230. Information of the physical device 230 is sensing information, such as temperature, pressure, speed, and position relating to the device. The abnormality detection unit 221 detects an abnormality of a control sequence including one or more commands issued to the monitoring target device, using a state model generated by the below-described learning system 300 (more specifically, learning unit 310). In the case where the physical device 230 periodically transmits the sensing information indicating the state of the physical device 230 to the HMI 120 or the log server 110, the learning system 300 may acquire the sensing information from the HMI 120 or the log server 110.

Herein, the “abnormality of a control sequence” denotes not only a collapse of the control sequence issued to the physical device 230, but also a control sequence issued in a situation not expected by the physical device 230. For example, even if a command is plausible as a command issued as a control sequence, in the case where the probability of issuing such a command is very low given the situation of the physical device 230, the control sequence is determined as abnormal.

Specifically, the abnormality detection unit 221 detects the control sequence issued to the monitoring target physical device 230, and, in the case where the monitoring target physical device 230 in response to the detected control sequence is not in a normal state based on the state model, determines that the control sequence is abnormal.

The abnormality detection unit 221 may detect the state of the monitoring target physical device 230, and, in the case where a control sequence not expected to be issued in the state of the physical device 230 based on the state model is issued to the monitoring target physical device 230, determine that the control sequence is abnormal.

That is, the abnormality detection unit 221 may acquire the state of the control target physical device 230, and, in the case where the state exceeds an acceptable range based on the state model, detect an already issued control sequence as abnormal. Alternatively, the abnormality detection unit 221 may acquire the state of the physical device 230, and detect a control sequence not expected to be issued to the physical device 230 based on the state model as abnormal.

The physical device 230 is a device that is a control target (monitoring target). Examples of the physical device 230 include a temperature control device, a flow rate control device, and an industrial robot. Although two physical devices 230 are depicted in the example in FIG. 1, the number of physical devices 230 is not limited to two, and may be one, or three or more. Moreover, the number of types of physical devices 230 is not limited to one, and may be two or more.

The following description assumes that the physical line system 200 is a system of a line for operating physical devices such as industrial robots, and the control line system 100 is a system including components other than the physical line system 200. Although the structure of the industrial control system 10 is divided between the control line system 100 and the physical line system 200 in this exemplary embodiment, the method of configuring the system lines is not limited to that in FIG. 1. Moreover, the structure of the control line system 100 is an example, and the components in the control line system 100 are not limited to those in FIG. 1.

The learning system 300 includes a learning unit 310 and a transmission/reception unit 320.

The learning unit 310 learns the state model representing the normal state of the system including the physical device 230 (i.e. physical line system 200), based on a control sequence issued from the DCS/PLC 210 and data indicating a state detected from the physical device 230 when the control sequence is issued.

The data indicating the control sequence and the state of the device is collected by the operator or the like in a state in which the system is determined as normal. The data may be collected before or during operation of the system.

Specifically, the learning unit 310 generates a feature indicating the correspondence relationship between the control sequence and the state of the device when the control sequence is issued, as the state model. The “state of the device” herein denotes a value or range acquired by a sensor and the like for detecting the state of the device when the control sequence is issued. Hence, the state model may be, for example, a model representing a combination of the control sequence and the value or range indicating the state of the device detected by a sensor and the like at normal time.

The timing of detecting the state from the physical device 230 may be the same as the timing of issuing the control sequence, or a predetermined period (e.g. several seconds to several minutes) after the timing of issuing the control sequence.

For example, in the case where the physical device 230 is a device that reacts immediately, such as a robot, the timing of detecting the state of the physical device is preferably approximately the same as the timing of issuing the control sequence. In the case where the physical device 230 is a large plant and the temperature in the plant after the control sequence is issued is to be detected, the timing of detecting the state of the device is preferably the predetermined period involving a temperature increase after the timing of issuing the control sequence.

Hence, depending on the physical device 230 and the control sequence, the learning unit 310 may generate the state model using, for the feature, the state of the device the predetermined period after the control sequence is issued.

The transmission/reception unit 320 receives the data indicating the control sequence and state of the physical device via the NW switch 220, and transmits the feature generated as the state model to the NW switch 220 (more specifically, the abnormality detection unit 221). The abnormality detection unit 221 subsequently detects an abnormality of a control sequence using the received state model (feature).

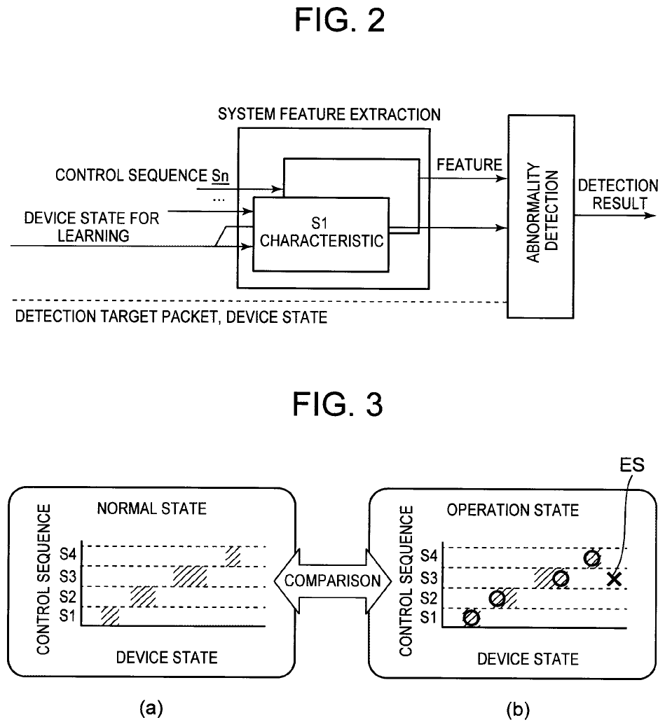

FIG. 2 is an explanatory diagram depicting an example of a process of generating a state model and detecting an abnormality of a system. First, a control sequence Sn is input to the learning unit 310. The input control sequence Sn may be, for example, automatically generated by extracting a series of commands for the control device from learning packets, or individually generated by the operator or the like.

Further, the state of the device detected from the physical device 230 in response to the input control sequence Sn is input to the learning unit 310. That is, a combination of the control sequence Sn and the state detected from the physical device 230 in response to the control sequence Sn is input to the learning unit 310. Based on the input information, the learning unit 310 extracts the state of the device when the control sequence Sn is issued, as a feature of the normal state.

The learning unit 310 generates a feature represented by a combination of the control sequence and its characteristic, as a state model. That is, the feature is information indicating the value or range of the state of the physical device 230 when the control sequence Sn is issued. The transmission/reception unit 320 transmits the feature to the abnormality detection unit 221.

The abnormality detection unit 221 holds the received feature (state model). The abnormality detection unit 221 then receives a detection target packet including a control sequence and a device state, and, upon detecting that the control sequence is abnormal, outputs the detection result.

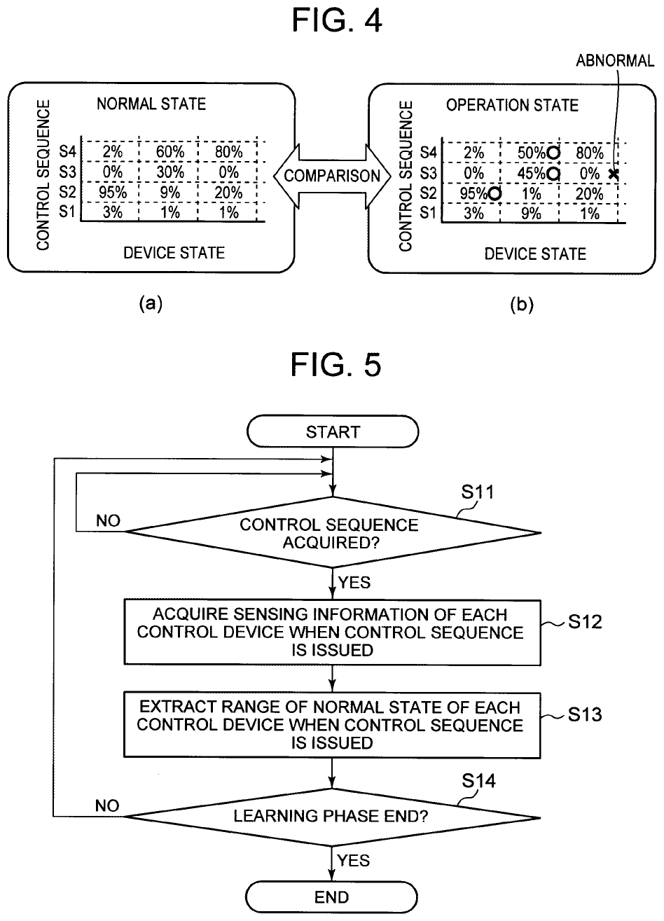

FIGS. 3 and 4 are each an explanatory diagram depicting an example of a process by which the abnormality detection unit 221 detects operating state incompatibility. For example, in FIG. 3(a), the hatched parts indicate a normal state in the relationship between control sequences and device states. When the abnormality detection unit 221 detects a state ES outside the range of the normal state in an operation state depicted in FIG. 3(b), the abnormality detection unit 221 determines the control sequence to be in an abnormal state (e.g. attacked state).

For example, FIG. 4(a) depicts the probability of occurrence of each control sequence in a device state. When, in an operation state depicted in FIG. 4(b), the abnormality detection unit 221 detects a state ES in which a control sequence whose probability of occurrence in a device state is low is issued, the abnormality detection unit 221 determines the control sequence to be in an abnormal state.

The learning unit 310 and the transmission/reception unit 320 are implemented by a CPU of a computer operating according to a program (model learning program). For example, the program may be stored in a storage unit (not depicted) included in the learning system 300, with the CPU reading the program and, according to the program, operating as the learning unit 310 and the transmission/reception unit 320. The learning unit 310 and the transmission/reception unit 320 may operate in the NW switch 220.

The abnormality detection unit 221 is also implemented by a CPU of a computer operating according to a program. For example, the program may be stored in a storage unit (not depicted) included in the NW switch 220, with the CPU reading the program and, according to the program, operating as the abnormality detection unit 221.

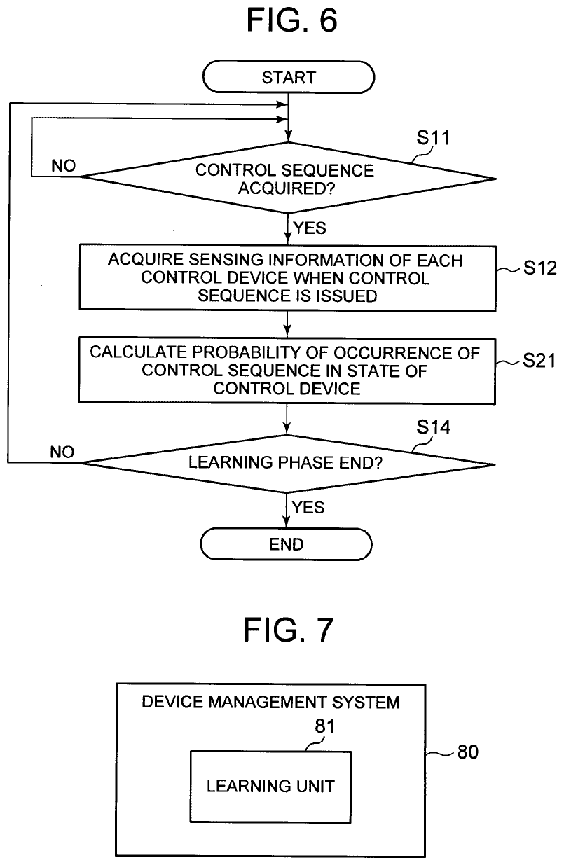

Operation of the device management system in this exemplary embodiment will be described below. FIGS. 5 and 6 are each a flowchart depicting an example of operation of the device management system in this exemplary embodiment. The example in FIG. 5 relates to a learning phase corresponding to FIG. 3 in which the learning unit 310 receives a control sequence and the state of the device in response to the control sequence and generates a feature.

The learning unit 310 determines whether a control sequence is acquired (step S11). In the case where a control sequence is not acquired (step S11: No), the learning unit 310 repeats the process in step S11.

In the case where the control sequence is acquired (step S11: Yes), the learning unit 310 acquires sensing information of each control device when the control sequence is issued (step S12). That is, the learning unit 310 acquires the state detected from the control target device when the control sequence is issued.

The learning unit 310 extracts the range of the normal state of each control device when the control sequence is issued (step S13). Specifically, the learning unit 310 determines the range of the normal state using the sensing information acquired from each control device. The normal state may be determined by any method. For example, the learning unit 310 may determine the range of the normal state while excluding a predetermined proportion of upper and lower extreme data.

The learning unit 310 determines whether to end the learning phase (step S14). For example, the learning unit 310 may determine whether to end the learning phase depending on an instruction from the operator, or by determining whether a predetermined amount or number of processes are completed. In the case where the learning unit 310 determines to end the learning phase (step S14: Yes), the learning unit 310 ends the process. In the case where the learning unit 310 determines not to end the learning phase (step S14: No), the learning unit 310 repeats the process from step S11.

The example in FIG. 6 relates to a learning phase corresponding to FIG. 4 in which the learning unit 310 receives a control sequence and the state of the device in response to the control sequence and generates a feature. The process of acquiring a control sequence and sensing information is the same as the process in steps S11 to S12 in FIG. 5.

The learning unit 310 calculates the probability of occurrence of the control sequence in a state of the control device (step S21). Specifically, based on the relationship between each control sequence and sensing information acquired from each control device, the learning unit 310 determines the probability of occurrence of the control sequence in a device state. The subsequent process of determining whether to end the learning phase is the same as the process in step S14 in FIG. 5.

As described above, in this exemplary embodiment, the learning unit 310 learns the state model representing the normal state of the system including the control target device, based on a control sequence and data indicating a device state detected from the control target device when the control sequence is issued. With such a structure, inappropriate control can be detected to appropriately manage the target device.

That is, in this exemplary embodiment, the normal state of the device corresponding to the control sequence is held as the state model (feature value), and monitoring is performed based on the state model. Therefore, even in the case where an attack such as rewriting a control sequence is made, inappropriate control is detected to promptly find the attack, so that the target device can be appropriately managed.

An overview of the present invention will be given below. FIG. 7 is a block diagram schematically depicting a device management system according to the present invention. A device management system 80 according to the present invention includes a learning unit 81 (e.g. learning unit 310) which learns a state model representing a normal state of a system including a control target device (e.g. physical device 230), based on a control sequence representing one or more time-series commands and data indicating a state of the control target device when the control sequence is issued.

With such a structure, inappropriate control can be detected to appropriately manage the target device.

Specifically, the learning unit 81 may generate a feature indicating a relationship between the control sequence and a normal state of the control target device when the control sequence is issued, as the state model.

The learning unit 81 may generate the state model using, for the feature, a state of the control target device a predetermined period after the control sequence is issued. With such a structure, even a device having a predetermined time lag from issuance of a control command to a state change can be controlled appropriately.

The device management system 80 may include an abnormality detection unit (e.g. abnormality detection unit 221) for detecting an abnormality of a control sequence including a command issued to a monitoring target device, using the state model.

Specifically, the abnormality detection unit may detect the control sequence issued to the monitoring target device, and, in the case where the monitoring target device in response to the detected control sequence is not in a normal state based on the state model, determine that the control sequence is abnormal.

The abnormality detection unit may detect a state of the monitoring target device, and, in the case where a control sequence not expected to be issued in the state of the monitoring target device based on the state model is issued to the monitoring target device, determine that the control sequence is abnormal. In other words, in the case where not a control sequence expected to be issued in the state of the monitoring target device but another control sequence is issued to the monitoring target device, the abnormality detection unit may determine the other control sequence as abnormal.

### REFERENCE SIGNS LIST

10 industrial control system
100 control line system
110 log server
120 HMI
130 engineering station
200 physical line system
210 DCS/PLC
220 NW switch
221 abnormality detection unit
230 physical device
300 learning system
310 learning unit
320 transmission/reception unit

1. A device management system comprising:
a learning unit, implemented by a processor, which learns a state model representing a normal state of a system including a control target device, based on a control sequence representing one or more time-series commands and data indicating a state of the control target device when the control sequence is issued.

2. The device management system according to claim 1, wherein the learning unit generates a feature indicating a relationship between the control sequence and a normal state of the control target device when the control sequence is issued, as the state model.

3. The device management system according to claim 2, wherein the learning unit generates the state model using, for the feature, a state of the control target device a predetermined period after the control sequence is issued.

4. The device management system according to claim 1, comprising
an abnormality detection unit, implemented by the processor, which detects an abnormality of a control sequence including a command issued to a monitoring target device, using the state model.

5. The device management system according to claim 4, wherein the abnormality detection unit detects the control sequence issued to the monitoring target device, and, in the case where the monitoring target device in response to the detected control sequence is not in a normal state based on the state model, determines that the control sequence is abnormal.

6. The device management system according to claim 4, wherein the abnormality detection unit detects a state of the monitoring target device, and, in the case where a control sequence not expected to be issued in the state of the monitoring target device based on the state model is issued to the monitoring target device, determines that the control sequence is abnormal.

7. A model learning method comprising
learning a state model representing a normal state of a system including a control target device, based on a control sequence representing one or more time-series commands and data indicating a state of the control target device when the control sequence is issued.

8. The model learning method according to claim 7, wherein a feature indicating a relationship between the control sequence and a normal state of the control target device when the control sequence is issued is generated as the state model.

9. A non-transitory computer readable information recording medium storing a model learning program, when executed by a processor, that performs a method for learning a state model representing a normal state of a system including a control target device, based on a control sequence representing one or more time-series commands and data indicating a state of the control target device when the control sequence is issued.

10. The non-transitory computer readable information recording medium according to claim 9, wherein a feature indicating a relationship between the control sequence and a normal state of the control target device when the control sequence is issued is generated, as the state model.
